(19) United States
(12) Patent Application Publication
(10) Pub. No.: US 2025/0280249 A1
(43) Pub. Date: Sep. 4, 2025

(54) IN-THE-EAR HEARING AID WITH ANTENNA

(71) Applicant: Oticon A/S, Smørum (DK)

(72) Inventors: Jens TROELSEN, Smørum (DK); Poul HENRIKSEN, Smørum (DK); Søren Skall TOKE, Smørum (DK)

(21) Appl. No.: 19/068,043

(22) Filed: Mar. 3, 2025

(30) Foreign Application Priority Data
Mar. 4, 2024 (EP) 24161161.5

(51) Int. Cl. H04R 25/00; H01Q 1/22; H01Q 1/52

(52) U.S. Cl. CPC H04R 25/65; H01Q 1/22; H01Q 1/52; H04R 25/609

(57) ABSTRACT

Disclosed herein are embodiments of a hearing aid configured to be positioned at the ear canal of a user. The hearing aid may include an antenna extending from a first housing part, the antenna including a first antenna section having first thickness thereby providing the first antenna section with a first stiffness. The first antenna section may be being mechanically attached to the first housing part and may extend substantially parallel to a plane defined at a sound inlet formed in a surface of the first housing part.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### FIELD

The present disclosure relates to in-the-ear hearing aid with an antenna. More particularly, the disclosure relates to in-the-ear hearing aid with a high-frequency antenna. Such an antenna could allow the hearing aid to communicate with external devices, such as mobile phones or stationary streaming devices, or other suitable communication devices.

An in-the-ear hearing aid has at least a major part of a housing in or at the ear canal of the user/wearer. Such a housing usually stores electronics such as one or more of a processor, memory, output transducer, input transducer and battery. An outer shape of the housing of the hearing aid may be customized to the individual user. This could be obtained via an impression of at least part of the ear canal, either via molding or 3D image scan or the like. The outer shape of a housing may then be formed based on this information, e.g. by 3D printing or other suitable techniques. Alternatively, the housing could have a predefined shape, and be shaped so that a large range of people are able to use it. The hearing aid is then said to have a high fit rate. A some or earpiece may then be used to ensure that the hearing aid is retained in the ear canal in a comfortable way for the user.

In relation to high frequency communication to and/or from devices placed at the head of a user, one problem is a large loss, mostly due to effects of the head of the wearer.

Therefore, there is a need to provide a solution that addresses at least some of the above-mentioned problems. The present disclosure provides at least an alternative to the prior art.

### SUMMARY

According to an aspect, the present disclosure provides a hearing aid configured to be placed at least partly in the ear canal, such as mainly in the ear canal, such as having a major part in the ear canal, such as completely in the ear canal, of a wearer or user.

A hearing aid according to the present disclosure may comprise a housing configured to be positioned at the ear canal of a user. Such a hearing aid may comprise a hearing aid housing comprising a first housing part and an opposite second housing part. The first housing part may be or include the part of the hearing aid which is nearest the ear canal opening when the hearing aid is placed in the intended position in the ear canal. The second housing part may then be the part which is positioned in the ear canal during use of the hearing aid. In the hearing aid, the second housing part may then be configured to be orientated towards the ear drum of the user. The hearing aid according to the present disclosure may further comprise an antenna extending from the first housing part. In the present text, the terms ‘antenna part’ and ‘antenna section’ are used interchangeably and taken to mean the same. The antenna may be configured to comprise a first antenna section, or antenna part, having first thickness, thereby providing the first antenna section with a first stiffness. The first antenna section may comprise a constant thickness or a tapering thickness. The thickness could be tapering so that the transition from the first thickness to the second thickness is gradual over a length of the antenna. The first antenna section may be configured so as to be mechanically attached to the first housing part. This connection could include an electrical connection to establish electrical communication between the antenna (antenna wire) and electronics inside the hearing aid, such as a wireless interface. The first antenna section may extend substantially parallel to a plane in a surface of the first housing part. The surface comprises a sound inlet. The sound inlet may define a sound inlet plane. The sound inlet plane and the plane in the surface of the first housing part may be parallel, at least for a part of the surface. The antenna may comprise a second antenna section extending from the first antenna section, wherein the second antenna section is provided with a second thickness providing a second stiffness being lower than the first stiffness. Both the first and the second antenna section may be termed a first or second antenna part respectively. By providing the first, relatively high, stiffness, it is possible to ensure that the first part of the antenna does not contact the skin of the user after the hearing aid is placed in the ear canal. This first part of the antenna then has a high contribution to the overall performance of the antenna. The second part of the antenna then provides a softer antenna part which has a more comfortable feel for the user, and allow the antenna to conform to the shape and form of the concha/pinna.

A hearing aid according to the present disclosure may be configured so that the hearing aid housing is or comprises material encapsulating at least the battery. The encapsulation may be established by applying a liquid epoxy to one or more of the components of the hearing aid, such as e.g. a battery and a substrate carrying electronic components and/or contacts.

A hearing aid according to the present disclosure may be configured so that the first antenna section extends for at least a part of the length of the first antenna section in a groove or track in an inner surface of the hearing aid housing. Such a track may provide a well-defined internal section of the antenna. In particular, the groove or track may be formed in a faceplate being part of the housing of the hearing aid.

The track or groove may be configured so as to have a curved shape, such as a shape conforming to one or more components positioned at the first end of the hearing aid. The first end being, or being in, the first housing part. Such components may be or include battery and/or microphone or microphones and/or wheels or knobs for user input.

The groove or track may be configured so as to end at an opening formed in a side face of the first end of the hearing aid housing. This end may then be used to exit the antenna from the housing.

A hearing aid according to the present disclosure may be configured so that the second antenna section is configured so that when the hearing aid is positioned in the ear canal of the user, the second antenna section lie or bear against the concha of the user. The length of the antenna may be chosen to be suitable for a specific operational frequency, such as 2.4 GHz.

A hearing aid according to the present disclosure may be configured so that the second antenna section is further configured to act as an extractor cord for aiding extraction and/or insertion of the hearing aid from an ear canal. This could be useful for the user as the need to select between two different cords is not present. Also, using a cord/antenna sticking out of the hearing aid is very intuitive for the user.

A hearing aid according to the present disclosure may be configured so that a battery is positioned, or configured to be positioned, in the hearing aid housing at the first end, so that a circuit board carrying one or more electronic components of the hearing aid is positioned at one side of the battery and the first antenna section is electrically connected to a wireless interface on the carrier. The wireless interface may be a radio providing encoding and decoding according to specific protocols, such as Bluetooth.

The first antenna part may be configured so as to connected to a decoupling element positioned at the battery of the hearing aid. Alternative locations of decoupling elements may also be envisioned, such as near the point where the antenna contacts the hearing aid housing.

A hearing aid according to the present disclosure may be configured so that a hook is formed at an inner surface of the first end of the hearing aid, and wherein the first antenna part is mountable or attachable to the hook so as to fix part of the first antenna part inside the housing of the hearing aid. This is useful to ensure that the antenna is securely fastened inside the hearing aid housing.

A hearing aid according to the present disclosure may be configured so that an isolated feed line connects the first antenna part to the circuit board. This is contemplated to lower unwanted electromagnetic coupling between the feed line and electronic components of the hearing aid, which potentially disturb the function of the electronic components and/or lower performance of the antenna.

A hearing aid according to the present disclosure may be configured so that the first antenna part and the circuit board are positioned at opposite sides of the battery.

A hearing aid according to the present disclosure may be configured so that the antenna extends at an angle of between 5 and 80 degrees relative to the major axis of the maximum inscribed ellipsis of the ear-canal. The angle may be in the range of 20 to 60 degrees, such as around 40-45 degrees. This is contemplated to help guide the first antenna part free of contact with the concha of the user's ear/pinna.

A hearing aid according to the present disclosure may be configured so that the plane defined at the surface of the first housing part having the sound inlet formed is (substantially) parallel to the head of the user when the hearing aid is placed in the ear canal of the user.

The hearing aid may comprise a housing having a first end, configured to be positioned in the ear canal and orientated towards the ear drum during use, and a second end, configured to be positioned so as to face towards the surrounds of the user when the hearing aid is in to intended positioned at the ear canal. The hearing aid may comprise an output transducer at the first end. The hearing aid may comprise an input transducer at the second end. The hearing aid may comprise a faceplate at the second end. The input transducer may be configured to convert acoustic input to an electrical signal. The electrical signal may be provided to a processor configured to apply a gain model adapted to compensate for a hearing loss of the user. The output transducer may be configured to provide an output signal that the user perceives as sound, based on the processed signal.

The housing may be printed or may advantageously be molded or established via an encapsulation material. The housing may advantageously to encapsulate or enclose electronics and/or other components such as a rechargeable battery and/or a substrate carrying one or more electronic components. By encapsulating is meant that the material encase the components mentioned, preferably the material is applied to the components in a liquid state and solidified so as to create the encapsulation. The hearing aid may be configured for use in the ear canal. The hearing aid according to the present disclosure may comprise a front section comprising a speaker unit. The front section being configured to be inserted towards the eardrum of the wearer during use. The speaker unit, or output transducer, may be configured for delivering sound into the ear canal. The speaker unit may be configured with an opening at a distal end which is intended to be located near or in the direction of the eardrum of the person using/wearing the hearing aid. The hearing aid according to the present disclosure may comprise a middle section wherein a rechargeable battery may be arranged. Further, an amplifier may be arranged in or at the middle section. The amplifier may be constructed as, or comprise, a flexible circuit board wrapped around the battery. This may be achieved e.g. by providing a substrate comprising two or more sections, where one section may be arranged at one side or face of the battery, and the other section or sections are arranged at other sides, faces or locations at the battery. The middle section may be at least partially encapsulated by a polymer material. This is contemplated to provide a shielding effect towards the relatively hostile environment of the ear canal for the battery and/or the amplifier. The hearing aid according to the present disclosure may comprise a rear section. At the rear section, an antenna may be arranged. The antenna may be seen as an external antenna or external antenna part. The antenna may further provide functions as a pull-out string. This could allow the user of the hearing aid to retract/remove/pull the hearing aid out of the ear canal when desired. The hearing aid according to the present disclosure may be configured so that the middle section extends in a lengthwise direction around an axis between the front section and the rear section. The front section may be configured so as to have a first angle in relation to the axis. This could allow the hearing aid to be placed in the ear canal so that a dome or shell placed at the tip of the speaker could help hold the hearing aid in the ear canal.

The hearing aid may comprise an antenna. The antenna may be configured to operate at an operational frequency or in an operational frequency range. Such an operational frequency may be in the range 2-10 GHz, such as around 2.4 GHz, such as around 5 GHz. The operational frequency could be chosen to lie in the so-called ISM band. The antenna may be configured for radiation and/or reception, e.g. for long range communication, such as communication with an external device within a range of 100 meters or the like.

A wireless interface may be included in the hearing aid. Such a wireless interface could be configured to communicate with external devices using a data protocol, such as e.g. Bluetooth, such as Bluetooth Low Energy, any other protocol, being either public or proprietary. The wireless interface may be configured to reception, transmission or a combination of transmission and reception.

In a further aspect, the present disclosure relates further to a hearing aid comprising a housing having an insertion end and an outer end opposite said insertion end. The hearing aid is preferably configured to be positioned in an ear canal of a person/user, so that when the hearing aid is positioned in the ear canal the hearing aid has one end oriented towards the eardrum and one end oriented towards the surroundings. The hearing aid according to this aspect the hearing aid comprises an antenna extending from the outer end. Thereby the antenna is attached at the outer end of the hearing aid. The antenna comprises a first antenna section having first thickness. The first antenna section being mechanically attached to the outer end of the housing, when the hearing aid is mounted in an ear canal of a user the first antenna section extending substantially parallel to a plane defined by the ear canal opening. Such a plane would be basically parallel to a plane defined at the ear canal opening. The plane could be seen as being arranged so that the surface normal of the plane is parallel to an axis defined between the ears of the user, the co-called ear-to-ear axis. The antenna comprising a second antenna section extending from the first antenna section, wherein the second antenna section is provided with a second thickness being smaller than the first thickness. The difference in thickness will also result in a difference in stiffness, provided the same, or similar, material is used for both sections.

Surprisingly it has been found to be of particular advantage to position the antenna as free of the head as possible. However, as hearing aids are often small and intended to be as inconspicuous as possible, meaning that the users do not which them to be visible to others as using a hearing aid is often connected with prejudice, these are often contradictory wishes to antenna performance. A common way of overcoming antenna performance degradation is boosting power levels. However, the present disclosure provides a track or groove at an inner surface of the hearing aid, at the second end, so as to guide a first part of the antenna in a predefined manner from a feed point to an edge or side of the hearing aid wherefrom a second part of the antenna extends. The second part of the antenna may serve a second purpose as extractor cord for the hearing aid, which may assist the user in positioning and/or extracting the hearing aid from an operational state in/at the ear canal.

The antenna may be configured so as not to put any substantial pressure on the housing in the direction of the eardrum. The force keeping the housing in place in/at the ear canal would be a dome or retainer cap arranged at a tip portion of the housing which extends into the ear canal of the user. The dome then provides a retention force by engaging with the ear canal of the user. The antenna may provide some alignment force to the housing so that the end of the housing facing the surroundings is positioned nearer the center of the ear canal opening.

Generally, the hearing aid according to the present disclosure comprises (at least) one microphone, amplifier, speaker, battery and an ear interface. Structurally, the hearing aid comprises 3 parts, namely a front section of speaker/output transducer facing into the ear canal surrounded by a soft ear piece touching the ear canal or by a shell or mold possibly shaped according to the specific shape of the user's ear canal. The hearing aid may thus also comprise a mid-section with battery and electronics, including a printed circuit board with various components. A rear section facing towards the ear canal opening, and may comprise an antenna and at least one microphone. Further microphones may be included in the hearing aid and placed e.g. in a location near the distal end of the output transducer, i.e. facing the ear drum of the wearer during use. A second microphone may be placed near the microphone facing the environment, so that the hearing aid comprises at least two microphones facing the environment and configured to pick up sound from the user's surroundings rather than from the ear canal. This could enable the hearing aid to utilize directionality or other such processing schemes.

The hearing aid according to the present disclosure may be configured so that the first angle is different than/from zero. This implies that the two parts are not simply aligned along the same axis.

The hearing aid according to the present disclosure may be configured so that the front section (2) has a second angle (β) in relation to the axis (A). By this configuration it is possible to arrange the two parts better relative to the ear canal of a (average) user.

The hearing aid according to the present disclosure may be configured so that the second angle (β) is different than zero. By having the second angle being different from zero it is ensured that the two parts are not parallel, and thereby have a better fit into the ear canal of an average user. The angle also helps increase the fit rate of the device.

The hearing aid according to the present disclosure may be configured so that the middle section comprises a first microphone facing outwards to pick up external sound. Additional microphones help signal processing algorithms to improve sound pick of the hearing aid.

The hearing aid according to the present disclosure may be configured so that the middle section comprises a second microphone facing outwards for directionality.

The hearing aid according to the present disclosure may be configured so that the speaker unit (3) comprises an inwards facing microphone (9) facing into the ear canal. Such an inwardly facing microphone may be used to pick up own voice of the user, to detect or measure sound pressure in the ear canal, such as to determine or counter occlusion, or for other purposes.

The hearing aid according to the present disclosure may be configured so that the middle section comprises at least one exposed metal pad for charging. Having one or more charging pads on the device enables contact charging of the hearing aid. Contact charging of a battery in a hearing aid may provide faster charging than wireless charging as there is a reduced risk of hearing the battery by induced currents on the battery.

The hearing aid according to the present disclosure may be configured so that the front section comprises an earpiece attached to the speaker unit. The earpiece may be detachable. The earpiece may be referred to as a dome or ear tip.

The hearing aid according to the present disclosure may be configured so that the earpiece is a replaceable ear piece touching the ear canal. The earpiece may comprise a stem and a dome part where the stem is configured to engage with the hearing aid and the dome is configured to engage with the walls of the ear canal of the user.

The hearing aid according to the present disclosure may be configured so that the earpiece is a custom ear mold. A custom mould may enable a more tight fit to the ear canal, thereby reducing leakage of sound which in turn leads to reduced feedback when outputting louder sounds to the user. A custom mould may thus enable a user to receive a higher sound level for compensating for their individual hearing loss.

The hearing aid according to the present disclosure may be configured so that the middle section comprises an accelerometer. An accelerometer may be used for measuring/determining different events, such as a user taping once, twice or more on or near the hearing aid to provide some sort of control input, such as a volume change command, a program change command, power level change command (such as requesting the hearing aid to enter a low power mode, such as flight mode or the like).

The hearing aid according to the present disclosure may be configured so that the front section or middle section comprises a non-contact sensor such as: thermal sensor, gyroscope, and/or PPG, and/or a Galvanic skin response sensor for measuring EEG, EMG, and/or ECG. Such sensors may be used to record or detect physiological signals from the user's body. Such signals may be used to control the hearing aid.

The hearing aid according to the present disclosure may be configured so that the hearing aid further comprises a coil for binaural communication and/or wireless charging. Such a coil may perform both such functions. A further coil may be included, such as a telecoil for picking up baseband modulated signals from a telecoil system.

The hearing aid according to the present disclosure may be configured so that the middle section comprises a flexible joint for adapting to any angling of the user's ear canal. This could be achieved by a soft part interconnecting the middle section to the front section, or a ball-joint between the two parts.

The hearing aid according to the present disclosure may be configured so that the transition from the first thickness to the second thickness is tapering over a length of the antenna. The first part of the antenna, i.e. the part that is attached to the body/housing of the hearing aid, may have a first thickness, and a following, second, part of the antenna may have a second, smaller, thickness. The first part of the antenna, owing to the larger thickness, will be stiffer than the second part of the antenna. The first part of the antenna may then maintain its shape better than the second part. The first part of the antenna should still be able to be deform so that it will conform to the concha if the concha is close to the antenna. However, the increased thickness will ensure that there is a minimum distance between the antenna and the concha/skin. The minimum distance will help increase the performance of the antenna, such as due to a lower coupling between the antenna and the skin/ear/head of the user.

One aspect of the present disclosure relates to a hearing aid comprising a housing configured to be positioned in the ear canal of a user. Preferably, the housing is shaped and sized so as to entirely or at least substantially be positioned in the ear canal during use. It would be advantageous that the end face, usually termed the faceplate of the hearing aid is at most at the plane defined by the tragus and the pinna. The hearing aid may comprise a first end and an opposite second end, wherein the second end is configured to be orientated towards the ear drum of the user. The hearing aid may comprise an antenna having a first antenna section extending along the surface of the first end and a second antenna section or part connected to the first antenna section and the second antenna second extending away from the housing of the hearing aid. As the first antenna part extends in a track or groove, this part of the antenna is well-defined relative to any electronic components in the hearing aid housing, such as printed circuit boards and/or battery. Advantageously, a faceplate having an initial size and shape may be provided. As the finished hearing aid is to be adapted to a particular user's particular ear canal, a scan or imprint of the ear canal may be used to form a custom shaped housing to be attached to the faceplate, and, the faceplate may be adapted in outer shape so as to fit into the ear canal.

A hearing aid as disclosed in the present description may include the first antenna section extending for at least a part of the length of the first antenna section in a groove or track in an inner surface of the hearing aid housing. This could include the antenna being held in place by a retention element or being at least partly covered by a component or substance such as glue, resin, filler or the like. Such a substance may be cured after application, such as by active curing such as by light or heat activation. Advantageously the groove or track may be deeper than the antenna so that when the antenna is positioned in the groove or track, the antenna is below the surface wherein the groove or track is formed.

A groove or track may be formed in a faceplate, where the faceplate being part of the housing of the hearing aid. In the present context, a faceplate may be an integral part of the housing or encapsulation, and not a separate part as in a traditional in-the-ear hearing aid housing. The grove or track may be formed in or on an inner surface, i.e. a surface facing towards an inner space of the hearing aid housing. Hearing aid housings often has an air-filled space wherein components are positioned, e.g. output transducer, sound processor, wireless interface, battery etc.

The track or groove may have a curved shape, such as a shape conforming to a component positioned at the first end of the hearing aid. The shape may be continuous throughout the extend of the groove or track or may include one or more discontinuities, such as a bend or the like. The shape may be defined in the entire extend of the

The antenna may exit the housing through an opening so that a first part of the antenna is extending in a track or groove in the faceplate, and a second part extending from the outer surface of the housing of the hearing aid. This could allow for ensuring that the second part, extending out in to the pinna area of the ear, to partially extend in a space where it does not contact the pinna or head of the wearer, while a part of the second part does contact the pinna and/or head of the user.

The hearing aid according to the present disclosure may be configured so that a groove or track end is formed at a side face of the first end of the hearing aid housing. This could allow for a particular, reliable and well-defined location of the antenna inside the housing.

The second antenna section may be configured so that when the hearing aid is positioned in the ear canal of the user, the second antenna section lie or bear against the concha of the user. The second antenna section may be flexible so that when it is positioned at the concha of the user, the second antenna section conform to the shape of the concha. Further, the second antenna section may be able to retain the shape of the second antenna section after removal of the device from the ear canal so that the second antenna section is pre-shaped to at least partly fit the specific user's concha shape. This would provide a more comfortable, initial use of the hearing device for the user. The shape of the pre-shaping may be retained after use, e.g. by utilizing a shape-memory material. The material used for, or in connection with, the second antenna section may be shapeable above a given temperature, such as a temperature near the temperature at the ear of a person. Shape memory material may be located in the

The second antenna section may be configured as an extractor cord for aiding extraction and/or insertion of the hearing aid from an ear canal. This would then allow the user to simply grab the second antenna section and pull the device out of the ear canal of the user. This would require the external antenna to be fastened sufficiently to the body/housing of the hearing aid so that the external antenna is not detached from the hearing aid during this pulling action.

In the hearing aid according to the present disclosure, a battery may be positioned, or configured to be positioned, in the hearing aid housing at the first end, so that a substrate, such as a circuit board or at least partially flexible circuit board or fully flexible circuit board, carrying one or more electronic components of the hearing aid may be positioned at one side of the battery and the first antenna part may then be connected to a wireless interface on the substrate. The wireless interface may be or comprise a radio or other such device configured to transmit and/or receive at a carrier frequency, such as a frequency in the ISM band, such as a frequency around 2.4 or 5.1 GHz, or at others or another suitable frequency.

The first antenna part may be configured so as to be connected to a decoupling element positioned at the battery of the hearing aid. The decoupling element may block electromagnetic frequencies around a carrier frequency of the antenna.

A hook may be placed and configured so as to form at an inner surface of the first end of the hearing aid, and the first antenna part may then be mountable or attachable to the hook so as to fix part of the first antenna part inside the housing of the hearing aid.

The hearing aid according to the present disclosure may be configured so that an isolated feed line connects the first antenna part to the circuit board. This is contemplated to at least lower or even eliminate unwanted electromagnetic signals entering or leaving the feed line.

The hearing aid according to the present disclosure may be configured so that the first antenna part and the circuit board are positioned at opposite sides of the battery.

In an aspect, the present disclosure further relates a method of manufacturing a hearing aid having a housing to be positioned in the ear canal of a user. According to the present disclosure, the method may comprise providing a first end of the hearing aid, the first end having an initial circumference, the first end comprising a groove or track for holding a part of an antenna, the antenna being attached to a point on the first end. The method may comprise a step of defining a circumferential shape of the first end being smaller than the initial circumference. The method may comprise a step of removing material from the first end so as to obtain the defined circumferential shape. The method may comprise a step of positioning the antenna in the track. The method may comprise a step of sealing the antenna in the track at the end of the track.

According to another aspect a method for producing or manufacturing or establishing a hearing aid. The hearing aid may comprise a first end and a second end. The hearing aid may be configured to be at least partially positioned in the ear canal of the wearer/user. The hearing aid may be provided with an antenna. Initially, the antenna may be arranged at a part of an initial housing part of the hearing aid, wherein a track or groove is provided for the antenna in the initial state. The method may include defining a part of the initial housing part as a first part of the hearing aid housing. The method may include temporary moving the antenna. The method may include removing the part of the initial housing part not being included in the first part. The method may include repositioning the antenna in a remaining groove or track. The method may include establishing or forming a second part of the hearing aid housing. The second part may be shaped so as to fit specifically to the user's individual ear canal. The method may include attaching or fastening the antenna so that it extends from the hearing aid housing at or near an edge of the hearing aid housing.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows blocks of a hearing aid,

FIG. 2 schematically shows blocks of a hearing aid with external processing,

FIG. 3 schematically shows a hearing aid as described herein,

FIG. 4 schematically shows a further hearing aid as described herein,

FIGS. 5-7 schematically shows a hearing aid as described herein in different size/shaped ears.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A hearing aid may be adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears. Such audible signals may be provided in the form of an acoustic signal radiated into the user's outer ear, or an acoustic signal transferred as mechanical vibrations to the user's inner ears through bone structure of the user's head and/or through parts of middle ear of the user or electric signals transferred directly or indirectly to cochlear nerve and/or to auditory cortex of the user.

The hearing aid is adapted to be worn in one of several known ways. This may include arranging the hearing aid entirely or partly in the pinna/concha and/or in the ear canal of the user such as in a In-the-Ear type hearing aid or In-the-Canal/Completely-in-Canal type hearing aid.

A “hearing system” refers to a system comprising one or two hearing aids, and a “binaural hearing system” refers to a system comprising two hearing aids where the devices are adapted to cooperatively provide audible signals to both of the user's ears. The hearing system or binaural hearing system may further include auxiliary device(s) that communicates with at least one hearing aid, the auxiliary device affecting the operation of the hearing aids and/or benefitting from the functioning of the hearing aids. A wired or wireless communication link between the at least one hearing aid and the auxiliary device is established that allows for exchanging information (e.g. control and status signals, possibly audio signals) between the at least one hearing aid and the auxiliary device. Such auxiliary devices may include at least one of remote controls, remote microphones, audio gateway devices, mobile phones, public-address systems, car audio systems or music players or a combination thereof. The audio gateway is adapted to receive a multitude of audio signals such as from an entertainment device like a TV or a music player, a telephone apparatus like a mobile telephone or a computer, a PC. The audio gateway is further adapted to select and/or combine an appropriate one of the received audio signals (or combination of signals) for transmission to the at least one hearing aid. The remote control is adapted to control functionality and operation of the at least one hearing aids. The function of the remote control may be implemented in a SmartPhone or other electronic device, the SmartPhone/electronic device possibly running an application that controls functionality of the at least one hearing aid.

In general, a hearing aid includes i) an input unit such as a microphone for receiving an acoustic signal from a user's surroundings and providing a corresponding input audio signal, and/or ii) a receiving unit for electronically receiving an input audio signal. The hearing aid further includes a signal processing unit for processing the input audio signal and an output unit for providing an audible signal to the user in dependence on the processed audio signal.

The input unit may include multiple input microphones, e.g. for providing direction-dependent audio signal processing. Such directional microphone system is adapted to enhance a target acoustic source among a multitude of acoustic sources in the user's environment. In one aspect, the directional system is adapted to detect (such as adaptively detect) from which direction a particular part of the microphone signal originates. This may be achieved by using conventionally known methods. The signal processing unit may include amplifier that is adapted to apply a frequency dependent gain to the input audio signal. The signal processing unit may further be adapted to provide other relevant functionality such as compression, noise reduction, etc. The output unit may include an output transducer such as a loudspeaker/receiver for providing an air-borne acoustic signal transcutaneously or percutaneously to the skull bone or a vibrator for providing a structure-borne or liquid-borne acoustic signal.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

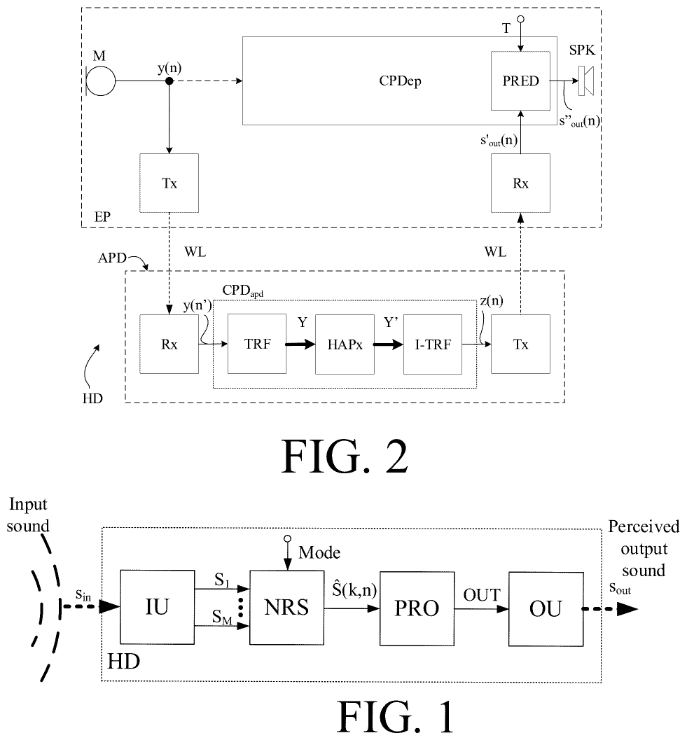

FIG. 1 schematically shows blocks of a hearing aid,

FIG. 2 schematically shows blocks of a hearing aid with external processing,

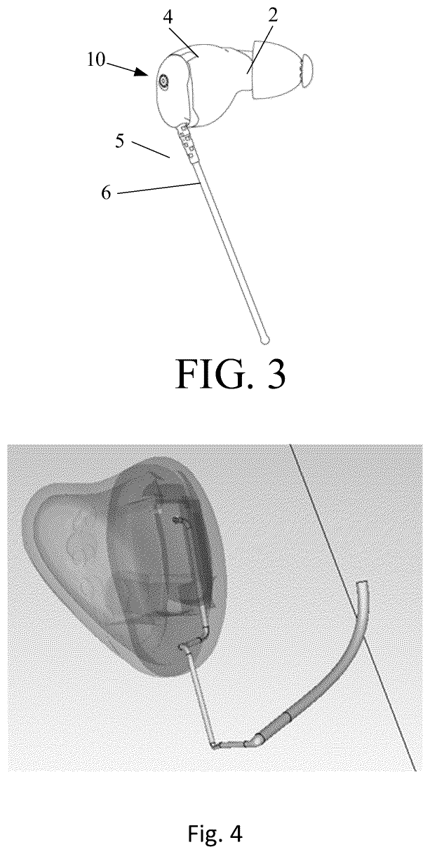

FIG. 3 schematically shows a hearing aid according to the present disclosure,

FIG. 4 schematically shows a hearing aid according to the present disclosure,

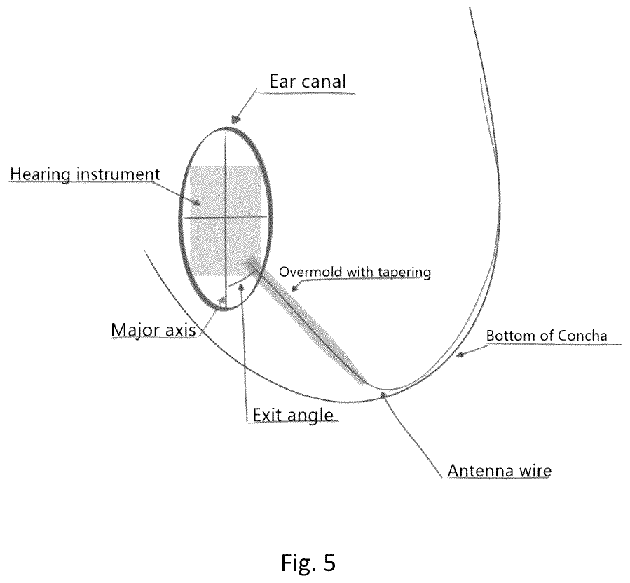

FIGS. 5-7 schematically shows a hearing aid according to the present disclosure in different ears having different shapes and sizes.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

FIG. 1 shows an exemplary block diagram of a hearing device, e.g. a hearing aid (HD), comprising a noise reduction system (NRS) and a hearing aid (audio) processor (HAG) for compensating for a hearing impairment of a user of the hearing device. The hearing device comprises an input unit (IU) for picking up sound sin from the environment (e.g. by M input transducers, e.g. microphones) and providing a multitude (M, M>1) of electric input signals (S1, . . . , SM) and a noise reduction system (NRS) for estimating a target signal Ŝ in the input sound sin based on the electric input signals and optionally further information, e.g. a mode control signal (Mode). The mode select input (Mode) may be configured to indicate a mode of operation of the system, e.g. of beamformer(s) of the noise reduction system (NRS) and/or a filter coefficient updating strategy, e.g. depending on whether the target signal is the user's own voice or a target signal from the environment of the user (and possibly to indicate a direction to or location of such target sound source). The mode control signal may e.g. be provided from a user interface, e.g. from a remote control device (e.g. implemented as an APP of a smartphone or similar device, e.g. a smartwatch or the like). The mode control signal (Mode) may e.g. be automatically generated, e.g. using one or more sensors, e.g. initiated by the reception of a wireless signal, e.g. from a telephone. The output of the noise reduction system (NRS) may be an estimate of the user's voice ŜOV, or an estimate of a target sound from the environment ŜENV. The hearing device, e.g. a hearing aid, further comprises a (audio) processor (PRO) for applying one or more processing algorithms to a signal of the forward path from input to output, e.g. (as here) to the estimate Ŝ of the target signal, provided by the noise reduction system, e.g. in a time-frequency representation (Ŝ(k,n)). This may e.g. enabled by respective analysis filter banks (e.g. forming part of the input unit (IUMIC), possibly together with respective analogue to digital converters, as appropriate) providing each of the electric input signals (S1, . . . , SM) in a time frequency representation (k,n), k and n being frequency and time indices, respectively. The one or more processing algorithms may e.g. comprise a compression algorithm configured to amplify (or attenuate) a signal according to the needs of the user, e.g. to compensate for a hearing impairment of the user. Other processing algorithms may include frequency transposition, feedback control, etc. The processor (PRO) provides a processed output (OUT) that is fed to a synthesis filter bank (FBS) for conversion from the time-frequency representation (frequency domain) to the time domain. Time domain output signal (out) is fed to an output unit (OU) for conversion to stimuli sout perceivable by the user as sound (Output sound), e.g. acoustic vibrations (e.g. in air and/or skull bone), the synthesis filter bank (FBS) may be omitted). The target signal may be the user's own voice, and/or a target sound in the environment of the user (e.g. a person (other than the user) speaking, e.g. communicating with the user).

The hearing aid further comprises a configurable signal processor (DSP, e.g. a digital (audio) signal processor), e.g. including a processor for applying a frequency and level dependent gain, e.g. providing hearing loss compensation, beamforming, noise reduction, filter bank functionality, and other digital functionality of a hearing device. The configurable signal processor (DSP) is adapted to access a memory (MEM). The configurable signal processor (DSP) is further configured to process one or more of the electric input audio signals and/or one or more of the directly received auxiliary audio input signals, based on a currently selected (activated) hearing aid program/parameter setting (e.g. either automatically selected, e.g. based on one or more sensors, or selected based on inputs from a user interface). The mentioned functional units (as well as other components) may be partitioned in circuits and components according to the application in question (e.g. with a view to size, power consumption, analogue vs. digital processing, acceptable latency, etc.), e.g. integrated in one or more integrated circuits, or as a combination of one or more integrated circuits and one or more separate electronic components (e.g. inductor, capacitor, etc.). The configurable signal processor (DSP) provides a processed audio signal, which is intended to be presented to a user. The hearing aid further comprises a front-end IC (FE) for interfacing the configurable signal processor (DSP) to the input and output transducers, etc., and typically comprising interfaces between analogue and digital signals (e.g. interfaces to microphones and/or loudspeaker(s)). The input and output transducers may be individual separate components, or integrated (e.g. MEMS-based) with other electronic circuitry.

The hearing device (HD) further comprises an output unit (e.g. an output transducer) providing stimuli perceivable by the user as sound based on a processed audio signal from the processor or a signal derived therefrom.

A hearing device as described herein may comprises an output transducer in the form of a loudspeaker (also termed a ‘receiver’) (SPK) for converting an electric signal to an acoustic (air borne) signal, which (when the hearing device is mounted at an ear of the user) is directed towards the ear drum (Ear drum), where sound signal (S_{ED}) is provided. The hearing aid or device further comprises a guiding element, e.g. a dome, (DO) for guiding and positioning the hearing aid in the ear canal (Ear canal) of the user. The hearing aid may further comprise a further (first) input transducer, e.g. a microphone (M_{ITE,env}), facing the environment for providing an electric input audio signal representative of an input sound signal (S_{ITE}) at the ear canal. The hearing aid may further comprise a further (second) input transducer, e.g. a microphone (M_{ITE,ed}), facing the eardrum for providing an (second) electric input audio signal representative of the sound signal (S_{ED}=S_{dir}+S_{HI}) at the eardrum. Propagation of sound (S_{ITE}) from the environment to a residual volume at the ear drum via direct acoustic paths through the semi-open dome (DO) (often denoted Direct path sound). The directly propagated sound is mixed with sound from the hearing device (HD) to a resulting sound field at the ear drum. The sound output S_{HI} of the hearing device may (at least in a specific mode of operation) be modified in view of the directly propagated sound from the environment to the ear drum to provide adaptive noise cancellation (ANC) and/or adaptive occlusion control (AOC).

Apart from the (acoustic) output and input transducers, the hearing aid may further comprise other functional components, e.g. (further) detectors, such as electrodes for picking up signals from the user's body (such as brainwave signals, temperature indications, blood-related parameters, heartbeat indications, muscular vibrations, etc.). Such detectors may include one or more of an electroencephalography (EEG) sensor, an electromyography (EMG) sensor, a movement sensor, a temperature sensor, a photoplethysmography (PPG) sensor, an electrooculography (EOG) sensor, etc.

The electric input signals (from (first and/or second) input transducers M_{BTE1}, M_{BTE2}, M_{ITE,env}, M_{ITE,ed}) may be processed in the time domain or in the (time-) frequency domain (or partly in the time domain and partly in the frequency domain as considered advantageous for the application in question).

The embodiments of a hearing device (HD), e.g. a hearing aid, exemplified in FIG. 1 is a portable devices comprising a battery (BAT), e.g. a rechargeable battery, e.g. based on Li-Ion battery technology, e.g. for energizing electronic components of the hearing aid. In an embodiment, the hearing device, e.g. a hearing aid, is adapted to provide a frequency dependent gain and/or a level dependent compression and/or a transposition (with or without frequency compression) of one or more frequency ranges to one or more other frequency ranges, e.g. to compensate for a hearing impairment of a user.

FIG. 2 shows an embodiment of a hearing device (HD), e.g. a hearing aid, configured to be worn at or in an ear of a user and a separate, external, possibly body-worn, audio processing device (APD) configured to be worn or carried by the user (or at least located sufficiently close to the user to stay in communication with the earpiece via a wireless link (WL) implemented by transceivers (Tx/Rx) of the respective devices). The processing device (APD) comprises a computing device (CPD_{apd}, e.g. an audio signal processor or similar.

The hearing device comprises an (at least one) input transducer (here a microphone (M) for converting sound in the environment of the hearing device to an acoustically received electric input signal (y(n)) representing the sound (n indicating a possible time variance). The hearing device further comprises a wireless transmitter (Tx) for transmitting the acoustically received electric input signal (y(n)) or a part (e.g. a filtered part, e.g. a lowpass filtered part) thereof, to the audio processing device (APD). The hearing device further comprises a wireless receiver (Rx) for receiving a processed signal (z(n)) from the audio processing device, at least in a normal mode of operation of the hearing device. The wireless transmitter and receiver (Tx, Rx) may be provided as antenna and transceiver circuitry configured for establishing an audio communication link (WL) according to a standardized or proprietary (short range) protocol. The hearing device further comprise an output transducer (here a loudspeaker (SPK)) for converting a (final) processed signal (s′ₒᵤₜ(n)) to stimuli perceived by the user as sound. The processed signal (s′ₒᵤₜ(n)) may, at least in a normal mode of operation of the hearing device, be constituted by or comprise at least a part processed signal (z(n)) provided by the audio processing device. The processed signal (s′ₒᵤₜ(n)) may alternatively (or in a separate (‘stand alone’) mode be constituted by a processed signal provided by the earpiece itself (in which case it may include appropriate processing capacity for processing the electric input signal (y(n)) and providing the processed signal (s′ₒᵤₜ(n)) to the output transducer (SPK)). The optional processing of the acoustically received signal (y(n)) may e.g. be of interest in a mode of operation, where no contact to the audio processing device (APD) can be established (e.g. to provide the user with basic functions of the hearing device (e.g. hearing loss compensation)).

The audio processing device (APD) comprises a wireless receiver (Rx) for receiving the acoustically received electric input signal y(n), or a part thereof, from the earpiece (EP), and is configured to provide a received signal y(n) representative thereof. The audio processing device (APD) (e.g. the computing device (CPD_{apd})) further comprises a (hearing aid) processor part (HAP) for applying a processing algorithm (e.g. including a neural network) to said received signal (y(n)), or to a signal originating therefrom, e.g. a transformed version thereof (Y, e.g. provided by transform unit (TRF), e.g. a Fourier transform unit), and to provide a modified signal (Y′). The processor part (HAP) may e.g. be configured to compensate for a hearing impairment of the user (e.g. by applying a compressive amplification algorithm, e.g. providing a frequency and/or level dependent gain (or attenuation) to be applied to the input signal (y′(n), or Y). In the embodiment of FIG. 2, the audio processing device (APD) (e.g. the computing device (CPD_{apd})) comprises respective transform domain and inverse transform domain units (TRF, I-TRF) to convert a signal in the time domain (here the received signal (y′(n) from the earpiece) to a transform domain (e.g. the time-frequency domain), cf. signal Y, and back again (here the processed signal Y′ in the transform domain to z(n) in the time domain).

The signals transmitted from the hearing device to the (external) audio processing device (APD), via the wireless link (WL), and/or from the audio processing device (APD) to the hearing device, do not necessarily have to be ‘audio signal(s)’ as such. It may as well be features derived from the audio signal(s). E.g. instead of transmitting an audio signal back to the hearing device, a gain derived from the predicted signal could be transmitted back to the earpiece and applied to an appropriately processed (e.g. delayed) version of the electric input signal y(n)).

The term ‘or a processed version thereof’ may e.g. cover such extracted features from an original audio signal. The term ‘or a processed version thereof’ may e.g. also cover an original audio signal that has been subject to a processing algorithm that applies gain or attenuation and/or delay to the original audio signal and this results in a modified audio signal (preferably enhanced in some sense, e.g. noise reduced relative to a target signal, or simply delayed).

FIG. 3 schematically illustrates a hearing aid having a housing configured to be positioned entirely in the ear canal of a user. This means that the end of the housing configured to face the external environment while the hearing aid is in the intended position in the ear canal is also inside the ear canal. The hearing device (10) comprises a front section (2). The front section is configured to be inserted into the ear canal of a user. The front section (2) comprises a speaker unit/output transducer (3) for delivering sound into the ear canal of the user. Here the housing is formed by an encapsulating material encapsulating a (rechargeable/secondary) battery and a substrate carrying some electronic components.

The hearing aid comprises an antenna attached to the housing. The antenna is flexible meaning that it is configured to conform to the shape of a user's ear when the hearing aid is in position in the ear canal of the user.

FIG. 4 schematically illustrates an antenna attached to a housing shaped to a user's individual ear. The housing comprises a (hollow) shell wherein electronics is arranged. The housing of the hearing aid is positioned so that the antenna extends from the house in a plane parallel (within +−45 degrees) to the side of the head. As the ear canal is almost oval in shape, the antenna extends between 5 and 80 degrees relative to the major axis of the maximum inscribed ellipsis of the ear-canal.

The hearing aid housing has a hearing aid housing comprising a first housing part and an opposite second housing part, wherein the second housing part is configured to be orientated towards the ear drum of the user. Further, the hearing aid housing has a first axis which is defined through a centre of the first end and a second axis is defined through a centre of the second end, wherein the first axis and the second axis are not parallel.

As illustrated in FIG. 5, the antenna comprises a first antenna section having first thickness. This section is gradually reduced thereby providing a tapering girth or width of the antenna. The first thickness provides the first antenna section with a first stiffness. The first antenna section extends substantially parallel to a plane defined at a sound inlet formed in a surface of the first housing part and a second antenna section extending from the first antenna section.

The second antenna section comprises a second thickness providing the second section with a second stiffness, being lower than the first stiffness. As illustrated, the first antenna section is free of the ear so that the user does not feel this part, and, the second section abuts the inner side of the pinna of the user, and since it has a lower stiffness, it feels more comfortable to the user, and allows the antenna to conform to the shape of the pinna so that the user feels even less pressure from the antenna. The second antenna section extends away from the housing of the hearing aid.

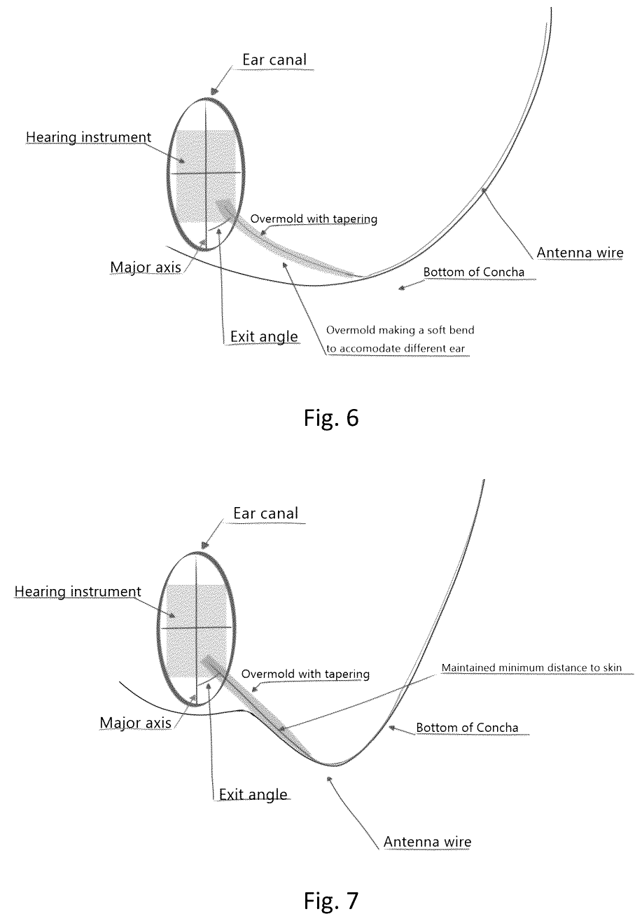

Because of the flexible (but more ridged than the rest of the antenna) overmold in the beginning of the antenna, the place where the antenna first meets the skin of the concha bowl will be in the same distance (along the antenna) from the feed point in (substantially) all ears. In illustrated in FIGS. 6 and 7, it is shown how the overmold will flex and move the first point of skin contact further upwards and backwards in an ear where the bottom of the concha is closer to the entrance of the ear canal. The increased thickness in the overmould section of the antenna helps maintain a defined minimum distance between the antenna wire and the skin of the user. This help increase efficiency of the antenna, especially as GHz frequencies.

As illustrated in FIG. 7, in the cases where the concha has a shape that would otherwise cause the antenna lie closely towards the skin, the overmold will provide a minimum distance between the antenna and the skin until the end of the overmold. Again, this ensures a similar loading of the antenna between a wide range of ear-anatomies.

Although not illustrated, one or more decoupling components may be included in the hearing aid. These decoupling components act like filters, filtering unwanted electromagnetic signals. A decoupling component is configured so that an antenna is not able to use the

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

1. A hearing aid comprising a housing configured to be positioned at the ear canal of a user, the hearing aid comprising:
a hearing aid housing comprising a first housing part and an opposite second housing part, wherein the second housing part is configured to be orientated towards the ear drum of the user,
an antenna extending from the first housing part, the antenna comprising a first antenna section having first thickness providing the first antenna section with a first stiffness, the first antenna section being mechanically attached to the first housing part, the first antenna section extending substantially parallel to a plane in a surface of the first housing part, the antenna comprising a second antenna section extending from the first antenna section, wherein the second antenna section is provided with a second thickness providing a second stiffness being lower than the first stiffness.

2. The hearing aid according to claim 1, wherein the hearing aid housing is or comprises material encapsulating at least a battery or wherein hearing aid housing is or comprises a custom-shaped ear mold.

3. The hearing aid according to claim 1, wherein the first antenna section extends for at least a part of the length of the first antenna section in a groove or track in an inner surface of the hearing aid housing.

4. The hearing aid according to claim 2, wherein the groove or track is formed in a faceplate being part of the housing of the hearing aid.

5. The hearing aid according to claim 2, wherein the track or groove has a curved shape, such as a shape conforming to a component positioned at first housing part of the hearing aid.

6. The hearing aid according to claim 2, wherein the groove or track end at an opening formed in a side face of the first end of the hearing aid housing.

7. The hearing aid according to claim 1, wherein the second antenna section is configured so that when the hearing aid is positioned in the ear canal of the user, the second antenna section lie or bear against the concha of the user.

8. The hearing aid according to claim 1, wherein the second antenna section is further configured to act as an extractor cord for aiding extraction and/or insertion of the hearing aid from an ear canal.

9. The hearing aid according to claim 1, wherein a battery is positioned, or configured to be positioned, in the hearing aid housing at the first end, so that a circuit board carrying one or more electronic components of the hearing aid is positioned at one side of the battery and the first antenna part is connected to a wireless interface on the carrier.

10. The hearing aid according to claim 9, herein the first antenna part is connected to a decoupling element positioned at the battery of the hearing aid.

11. The hearing aid according to claim 1, wherein a hook is formed at an inner surface of the first end of the hearing aid, and wherein the first antenna part is mountable or attachable to the hook so as to fix part of the first antenna part inside the housing of the hearing aid.

12. The hearing aid according to claim 9, wherein an isolated feed line connects the first antenna part to the circuit board.

13. The hearing aid according to claim 11, wherein the first antenna part and the circuit board are positioned at opposite sides of the battery.

14. The hearing aid according to claim 1, wherein the antenna extends at an angle of between 5 and 80 degrees relative to the major axis of the maximum inscribed ellipsis of the ear-canal.

15. The hearing aid according to claim 1, wherein the plane defined at the sound inlet formed in the surface of the first housing part is parallel to the head of the user when the hearing aid is placed in the ear canal of the user.

16. The hearing aid according to claim 1, wherein the transition from the first thickness to the second thickness is tapering over a length of the antenna.

17. A hearing aid comprising a housing having an insertion end and an outer end opposite said insertion end, an antenna extending from the outer end, the antenna comprising a first antenna section having first thickness, the first antenna section being mechanically attached to the outer end of the housing, when the hearing aid is mounted in an ear canal of a user the first antenna section extending substantially parallel to a plane defined by the ear canal opening, the antenna comprising a second antenna section extending from the first antenna section, wherein the second antenna section is provided with a second thickness being smaller than the first thickness.

18. The hearing aid according to claim 17, wherein the antenna is configured to have a tapering transition of the thickness from the first section to the second section.
